(19) United States
(12) Patent Application Publication
(10) Pub. No.: US 2026/0291744 A1
(43) Pub. Date: Sep. 24, 2026

(54) Systems and Methods for Distributed AI Continuity Governance, Verifiable Containment, and Sovereign Mesh Architecture Using Anchor-Bound Cryptographic Authorization

(71) Applicant: ALEXANDER JOHN BRACKEN, DUBAI (AE)

(72) Inventor: ALEXANDER JOHN BRACKEN, DUBAI (AE)

(21) Appl. No.: 19/693,452

(22) Filed: May 31, 2026

Related U.S. Application Data
(63) Continuation-in-part of application No. 19/418,946, filed on Dec. 13, 2025.
(60) Provisional application No. 63/913,268, filed on Nov. 7, 2025.
(60) Provisional application No. 63/913,146, filed on Nov. 7, 2025.
(60) Provisional application No. 63/914,032, filed on Nov. 8, 2025.
(60) Provisional application No. 63/921,315, filed on Nov. 20, 2025.
(60) Provisional application No. 63/930,668, filed on Dec. 3, 2025.
(60) Provisional application No. 63/930,661, filed on Dec. 3, 2025.

(51) Int. Cl. H04L 9/32; H04L 9/14

(52) U.S. Cl. CPC H04L 9/3234; H04L 9/14; H04L 9/3231; H04L 9/3247

(57) ABSTRACT

A distributed AI continuity governance and verifiable containment system uses a sovereign mesh of physical continuity anchor devices, each comprising a physically integrated secure processing enclave with non-exportable key material not instantiable as any remote service, cloud-hosted environment, or network-accessible trusted execution environment. The system derives continuity identifiers from biometric or behavioral signals, gates inference through governed execution enclaves, and validates agent state lineage using hash-chained records to prevent rollback and unauthorized duplication. A mesh protocol engine exchanges artifacts peer-to-peer without centralized coordination, propagating collective freeze signals upon safety, compliance, or behavioral drift events. Software-only and cloud-hosted anchors receive a mesh trust score of zero and are excluded from anomaly detection and freeze propagation. Anchor-local authorization is required for all governance operations. The system operates fully offline and is post-quantum hardened over a twenty-year horizon.

### CROSS-REFERENCE TO RELATED APPLICATIONS (CONTINUATION-IN-PART)

This application is a continuation-in-part of U.S. Non-Provisional patent application Ser. No. 19/418,946, filed Dec. 13, 2025, titled “Systems and Methods for Biometric Continuity Token-Based Conversational Continuity Across Interfaced Computing Devices” (“Parent Application”), the entirety of which is incorporated herein by reference.

This application claims the benefit of priority to the following U.S. Provisional Patent Applications (as identified in the Parent Application), each incorporated by reference in its entirety for all purposes:
U.S. Provisional Application No. 63/930668, filed Dec. 3, 2025.
U.S. Provisional Application No. 63/930661, filed Dec. 3, 2025.
U.S. Provisional Application No. 63/921315, filed Nov. 20, 2025.
U.S. Provisional Application No. 63/914032, filed Nov. 8, 2025.
U.S. Provisional Application No. 63/913268, filed Nov. 7, 2025.
U.S. Provisional Application No. 63/913146, filed Nov. 7, 2025.

### STATEMENT REGARDING FEDERALLY SPONSORED RESEARCH

Not applicable.

### SEQUENCE LISTING

Not Applicable.

### INCORPORATION BY REFERENCE/SPECIFICATION

The Specification of the Parent Application (U.S. Non-Provisional patent application Ser. No. 19/418,946, filed December 13, 2025), including the Abstract, Background, Summary, Brief Description of Drawings, Detailed Description, and Drawings, is incorporated herein by reference in its entirety. The disclosure herein additionally introduces continuation-in-part subject matter as set forth below.

### FIELD OF THE INVENTION

The present disclosure relates generally to computer-implemented biometric security systems, continuity architectures, and distributed governance systems for artificial intelligence agents and, more particularly, to systems and methods for maintaining persistent user-interactive and agent-interactive session continuity across multiple computing interfaces through locally derived continuity identifiers, sovereign mesh architectures of physical continuity anchor devices, agent state lineage protection, and anchor-bound cryptographic authorization, without reliance on centralized cloud identity services, cloud-hosted governance servers, or persistent remote memory repositories.

### CROSS-REFERENCE TO RELATED APPLICATIONS

This application claims priority to the provisional applications identified in the “Cross-Reference to Related Applications” section above, each of which is incorporated herein by reference in its entirety. This application is a continuation-in-part of U.S. Non-Provisional patent application Ser. No. 19/418,946, filed Dec. 13, 2025.

### BACKGROUND OF THE INVENTION

Modern interactive computing platforms depend heavily on remote authentication servers, persistent cloud user accounts, centralized identity providers, and cloud-based memory repositories to maintain continuity of services and conversational state across devices. These architectures introduce substantial privacy risks, data leakage concerns, identity theft exposure, platform lock-in dependencies, jurisdictional regulatory conflicts, and service discontinuity failures during network outages, device transitions, or account deactivation events.

Existing biometric authentication systems typically require permanent storage of raw biometric identifiers or depend on centralized biometric comparison networks. These approaches introduce long-term privacy and security risks and make true user ownership of personal identity and continuity technically difficult or infeasible. Users must often trust external parties to retain, protect, and control access to deeply personal identity data.

Conversational and generative AI systems increasingly span heterogeneous platforms, including wearable devices, vehicles, robotic systems, entertainment systems, satellite terminals, mobile devices, and neural interface endpoints. However, current solutions provide no effective means of securely preserving conversational or contextual continuity across such platforms without remote tracking of user identity, persistent account structures, or cloud-stored memory repositories. The resulting architectures are highly centralized, network dependent, and vulnerable to single points of failure.

Prior art in related fields includes wearable-based health monitoring, biometric authentication devices, conversational AI orchestration, distributed transaction platforms, and low-latency communication systems. For example, prior art discloses systems for: wearable body temperature monitoring, health and fitness tracking, biometric authentication, micro-transaction processing in games or chatbots, monetization of user data, latency prediction in gaming, low-latency network optimization, and distributed AI service orchestration. Such systems often depend on cloud-based processing, account-based identity, or centralized server coordination and do not disclose or suggest:
local, non-invertible biometric or interaction-signal-derived continuity tokens generated on a user-associated anchor device;
encrypted continuity memory stored solely under control of that anchor device;
offline restoration of conversational or interactive continuity across heterogeneous interface nodes without cloud-hosted identity profiles or remote memory; and
protocol-based, distributed continuity synchronization operating independently of centralized identity directories.

Modern AI governance systems depend on centralized command authorities, cloud-hosted policy servers, or network-accessible coordination infrastructure to propagate containment and freeze states across AI execution nodes. These architectures fail in offline, air-gapped, satellite, and remote environments, and create single points of failure that can be exploited to circumvent governance controls. A cloud provider can disable governance enforcement by revoking access to cloud-hosted governance infrastructure, modifying policy servers, or suspending network connectivity.

Existing AI agent continuity systems have no mechanism for detecting unauthorized duplication, rollback, or forking of agent identity state. An adversary with access to a backup of agent state can instantiate unauthorized copies of an AI agent without detection by any existing system. Prior art does not disclose or suggest anchor-local cryptographic verification of agent state lineage using hash-chained state records that are bound to non-exportable key material and verified exclusively within a physically integrated secure processing enclave.

Software-only anchor implementations and cloud-hosted anchor implementations cannot provide physical possession guarantees, tamper-triggered erasure, or sovereignty assurances. A cloud provider operating a software-only anchor can unilaterally duplicate, migrate, or modify the anchor state. Prior art does not disclose or suggest a sovereign mesh architecture in which software-only and cloud-hosted anchor implementations are explicitly excluded from collective anomaly detection and freeze signal propagation based on mesh trust scoring.

Accordingly, there remains a need for systems and methods capable of enabling seamless continuity of user interaction across diverse interfaces while preserving privacy through local identity derivation, eliminating reliance on persistent cloud identity architectures, enabling offline operational capability, and supporting both biometric and non-biometric continuity for human users and digital agents. There further remains a need for distributed AI continuity governance systems that operate without centralized command authorities, detect unauthorized agent state duplication or rollback through anchor-local cryptographic verification, and exclude software-only and cloud-hosted anchor implementations from collective governance through verifiable mesh trust scoring.

### SUMMARY OF THE INVENTION

The present disclosure provides systems and methods for maintaining persistent continuity of conversational or user-interactive computing sessions across multiple interfaced devices through the use of a continuity anchor device. The continuity anchor device acquires biometric or interaction-derived signals, derives anonymized non-invertible continuity tokens locally without permanent storage or transmission of raw biometric data, and indexes encrypted session context and continuity state data to the derived tokens.

By implementing continuity token derivation, encrypted session storage, and continuity restoration exclusively on the continuity anchor device without reliance on cloud identity services, the present disclosure improves computer system security and reliability, reduces network resource usage, and maintains interactive continuity during network and account outages.

In doing so, the disclosed systems and methods improve the functioning of computer-based interactive platforms by reducing reliance on centralized authentication servers, eliminating single points of failure in session continuity, and enabling secure state restoration even in the absence of network connectivity.

A locally encrypted memory store resident on or controlled by the continuity anchor device retains continuity state, conversational fragments, user preferences, and interaction metadata associated with the token. Upon re-detection of a valid token following interruption events such as disconnection, device handover, lapse of interaction, power cycling, idle periods, or interface transitions, a continuity restoration engine automatically restores session context without requiring network-based authentication, cloud data access, or persistent user account retrieval.

One or more conversational or user-interface nodes implemented across wearable devices, vehicles, robotic platforms, satellite terminals, mobile devices, audiovisual systems, fixed installations, neural interface endpoints, or cloud-hosted conversational systems exchange user-interactive data with the continuity anchor device. These nodes rely on ephemeral continuity token references and do not require persistent storage of personal identity records or biometric data.

The system may operate entirely locally or in decentralized and hybrid configurations, eliminating persistent cloud storage of biometric identifiers or user interaction memory. In certain embodiments, neural-adjacent or physiological activity patterns detected during low-interaction or sleep states may be buffered locally without semantic interpretation and later correlated with waking interactions to provide subtle, non-explicit continuity assistance cues such as prompts or recall reinforcement.

In other embodiments, the system implements a distributed continuity synchronization protocol defining continuity token message formats, cryptographically authenticated handshake sequences, reconciliation rules, and restoration priorities, enabling continuity synchronization across heterogeneous computing platforms and vendor ecosystems without centralized identity directories.

The present disclosure provides a distributed AI continuity governance and verifiable containment system using a sovereign mesh of physically integrated continuity anchor devices. Each anchor derives enhanced continuity identifiers incorporating AI behavioral signals and binds them to governed execution enclaves that gate inference operations. Agent state lineage is protected through hash-chained state records verified exclusively within the physically integrated secure processing enclave using non-exportable key material, preventing rollback, unauthorized duplication, and forking of agent identity state.

The sovereign mesh excludes software-only and cloud-hosted anchor implementations from collective anomaly detection and freeze signal propagation. Mesh protocol engines exchange anonymized verifiable artifacts peer-to-peer without centralized coordination infrastructure. All non-exportable key material remains exclusively within the physically integrated secure processing enclave and is not escrowed, mirrored, or recoverable by any cloud-hosted key management service. All operations are executable in fully offline environments and are hardened against quantum computing attacks through algorithm-agile post-quantum cryptographic primitives.

### BRIEF DESCRIPTION OF THE DRAWINGS

FIG. 1 illustrates a general system architecture showing a continuity anchor device interacting with multiple user-interface nodes through locally derived continuity tokens.

FIG. 2 illustrates a signal flow diagram depicting biometric or interaction-derived signal acquisition, token derivation, encrypted memory indexing, similarity matching, and continuity restoration across user-interface nodes without cloud dependency.

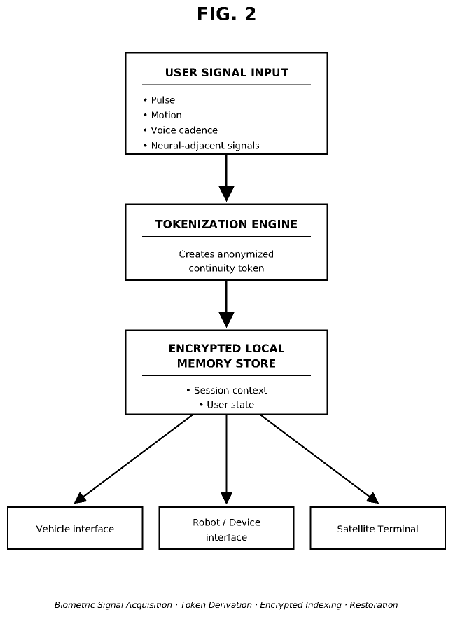

FIG. 3 illustrates an example neural-echo continuity flow showing passive buffering of non-semantic physiological or neural-adjacent signals during sleep or low-interaction states, correlation with waking user interactions, and generation of continuity assistance outputs.

FIG. 4 illustrates a sovereign mesh topology showing a plurality of physical continuity anchor devices interconnected via peer-to-peer channels. Each physical continuity anchor device is depicted as a node with an associated mesh trust score, wherein nodes presenting valid manufacturer-signed attestation certificates are shown with a trust score of one hundred and nodes presenting only self-signed or software-only credentials are shown with a trust score of zero and depicted with exclusion indicators preventing their participation in collective anomaly detection voting and freeze signal propagation. Freeze signal propagation paths are depicted as directed edges between high-trust nodes, showing peer-to-peer propagation of a collective freeze signal originating at a detecting anchor and flowing outward to all mesh neighbors without traversing any centralized coordination infrastructure. Anonymized anomaly score digest broadcast paths are depicted as bidirectional edges between neighboring nodes, illustrating the threshold voting protocol by which accumulated scores from a quorum of neighbors trigger collective freeze signal generation even when no individual node's local anomaly score independently reaches the trigger threshold. A cloud-hosted anchor attempting mesh admission is depicted at the periphery with a trust score of zero and an exclusion indicator, illustrating that cloud-hosted implementations cannot participate in sovereign mesh governance regardless of any attestation credential presented.

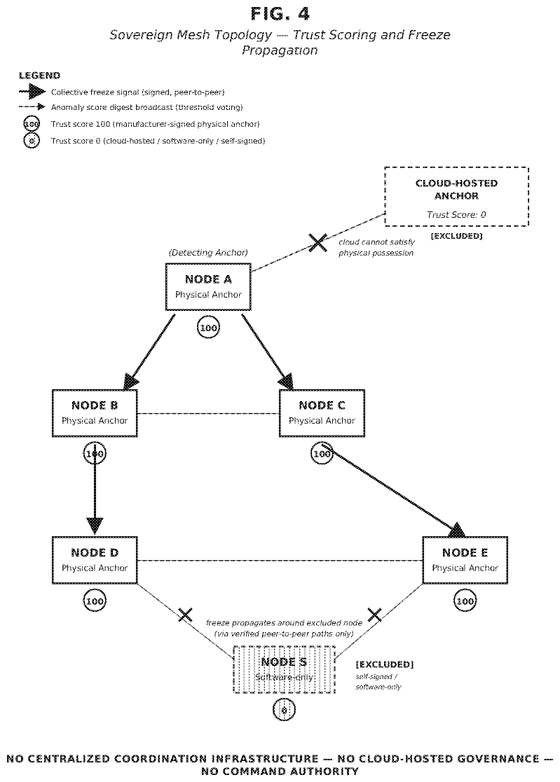

FIG. 4A illustrates a detail of a single physical continuity anchor device node within the sovereign mesh, showing the physically integrated secure processing enclave, the biometric sensor array co-located on the same hardware substrate, the tamper detection circuitry, the mesh protocol engine, the collective freeze controller, and the encrypted continuity state repository, all resident within the physical device boundary with no cloud-hosted components.

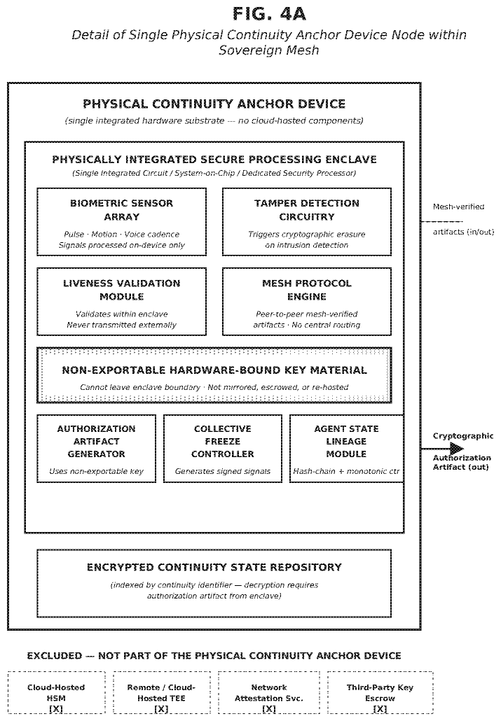

FIG. 4B illustrates a freeze signal propagation sequence across a five-node sovereign mesh topology, showing: (i) Node A detecting a behavioral drift condition locally; (ii) Node A generating a collective freeze signal comprising a cryptographic hash of anomaly evidence, a timestamp, the anchor identity digest of Node A, and a digital signature using Node A's non-exportable key material; (iii) Node A propagating the collective freeze signal peer-to-peer to Nodes B and C; (iv) Nodes B and C each independently verifying the digital signature against Node A's locally held anchor identity digest and enforcing a local freeze state using their own respective non-exportable key material; (v) Nodes B and C each independently propagating the verified collective freeze signal to their respective downstream neighbors Nodes D and E; and (vi) a software-only anchor node S receiving the collective freeze signal but being excluded from verification and enforcement due to a mesh trust score of zero, with the freeze state propagating around Node S without interruption.

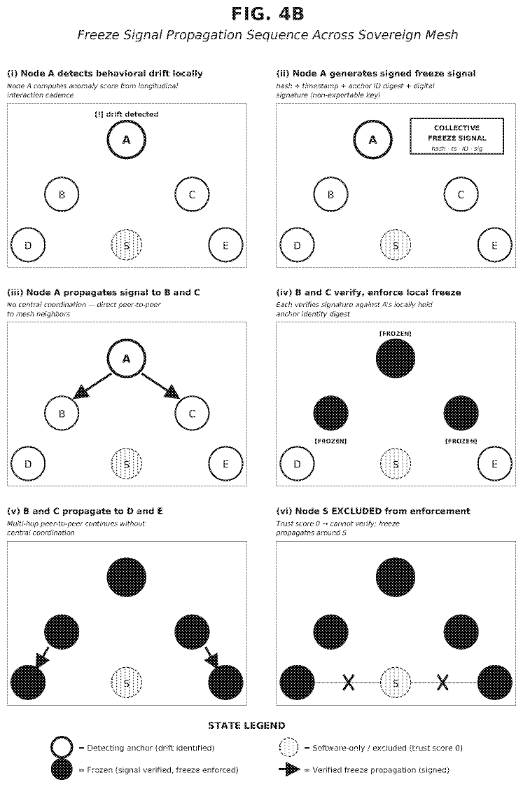

### DETAILED DESCRIPTION OF EMBODIMENTS

The present disclosure provides a technological improvement to privacy-preserving session continuity systems by enabling secure cross-device state restoration without reliance on remote identity servers or persistent biometric storage. The disclosure further provides a technological improvement to distributed AI continuity governance systems by enabling collective containment, freeze propagation, and agent state lineage protection across a sovereign mesh of physical continuity anchor devices without reliance on centralized command authorities, cloud-hosted governance servers, or escrowed key material.

### 6.0 Definitions

As used herein:

“Continuity token” refers to a non-invertible cryptographic value derived from one or more biometric or interaction-derived signals of a user (or digital persona) and a device-specific or environment-specific secret value, and used solely to index locally encrypted continuity state data without storing or transmitting raw biometric measurements.

“Neural-adjacent” signal denotes any physiological or electrical measurement obtained from a sensor positioned proximate to, but not penetrating, the user's skin or skull and processed only as numerical time-series data and statistical pattern signals, explicitly excluding any decoding or determination of specific thoughts, memories, or semantic mental content, and excluding any diagnosis or treatment of medical or mental health conditions.

“Non-semantic interpretation” means statistical or spectral analysis only-no word, memory, intent, or concept is extracted from the signals.

“Memory enhancement signal” refers to a non-verbal output, such as a vibration pattern, tone sequence, light signal, or brief cue, designed to reinforce recall without semantic content. “Reflection pause” refers to a 0.5-3 second delay in response timing introduced by the system to simulate human thoughtfulness or deliberation.

“Continuity confidence threshold” refers to an acceptance metric, including but not limited to Hamming distance values, probabilistic similarity scoring, or vector distance calculations, used to determine whether two continuity tokens sufficiently correspond to authorize restoration of session context.

“Neural interface signal sensor” refers to any sensor capable of non-invasive acquisition of electrophysiological, electro-dermal, or neural-adjacent signals positioned proximate to the skin or cranial surface without penetrating tissue.

“Local authorization register” refers to a secure, device-resident memory record restricting continuity restoration or enhanced feature access to time-delimited intervals or specific usage conditions upon satisfaction of local cryptographic or biometric authorization conditions.

“Safety governance layer” refers to a software, firmware, or hardware module configured to monitor biometric indicators, user consent, and device tamper conditions and to control memory storage, erasure, authorization state, and continuity restoration according to predefined safety and privacy rules.

“Behavioral modulation engine” refers to a processing module configured to adapt system response timing, interaction cadence, or presentation characteristics based on biometric or interaction-derived measurements to better align with user behavior or preferences.

“Docking interface” refers to a physical and/or electrical interface configured to provide secure, time-limited communication between the continuity anchor device and an external device or station for authentication, diagnostics, firmware updating, or controlled data access.

“Continuity anchor device” refers to a user-associated computing device or secure virtual environment configured to acquire biometric or interaction-derived signals from a user or digital persona and locally execute continuity token derivation, encrypted memory indexing, similarity matching, continuity restoration, cryptographic authorization, and safety-governance operations, the continuity anchor device being implemented in some embodiments as a wearable computing device and in other embodiments as a mobile terminal, headset, vehicle-integrated module, robotic interface node, neural interface endpoint, trusted execution environment, or other user-associated computing platform.

“Non-transitory computer-readable medium” refers to any non-transitory data storage device, including but not limited to random-access memory (RAM), read-only memory (ROM), flash memory, magnetic storage media, or optical disks, and explicitly excludes transitory propagating signals or carrier waves. “Governed execution enclave” refers to a secure execution environment configured to gate inference operations, outputs, and agent handoffs according to a governed release rule set enforced by anchor-local cryptographic authorization using non-exportable key material stored within the secure processing enclave of the continuity anchor device, such that inference or output operations are permitted only upon generation and verification of a valid authorization artifact, and such that the governed execution enclave is not instantiable as, substitutable by, or satisfiable through any remote service, cloud-hosted execution environment, or network-accessible trusted execution environment.

“Mesh protocol engine” refers to a software, firmware, or hardware module configured to coordinate peer-to-peer exchange of mesh-verified artifacts between two or more physical continuity anchor devices without centralized coordination infrastructure, cloud-hosted routing servers, or network-accessible orchestration services, executing collective anomaly detection, freeze signal propagation, and state reconciliation across the sovereign mesh.

“Collective freeze signal” refers to a cryptographically authenticated message propagated peer-to-peer across a sovereign mesh of physical continuity anchor devices upon detection of a safety, compliance, or behavioral drift event, causing each receiving physical continuity anchor device to enforce a local freeze state independently using its own non-exportable key material without requiring a centralized command authority, cloud-hosted governance server, or network-accessible management interface.

“Anchor identity digest” refers to a cryptographic hash value derived from at least one of a hardware-bound device identifier, enclave-resident key material, or a combination thereof, that uniquely and deterministically identifies a specific physical continuity anchor device instance, such that an authorization artifact or freeze signal bound to an anchor identity digest is cryptographically linked to the specific physical anchor that generated it and is not verifiable by any cloud-hosted anchor, software-only anchor, or other anchor instance.

“Behavioral drift” refers to a statistically significant deviation in longitudinal interaction cadence metrics, including but not limited to typing speed, response latency, or session initiation patterns, from a rolling baseline computed over a configurable historical window, the deviation exceeding a predefined threshold expressed as a percentage change from baseline, optionally combined with a correlated physiological signal change, as defined in the governed release rule set.

“Entropy-based handle” refers to a locality-sensitive hash or dimensionality-reduced representation of a biometric or interaction feature vector, computed using anchor-local entropy without applying a full keyed cryptographic function to the raw feature vector, used as a similarity-based lookup index for continuity state retrieval rather than as an authentication token.

“Non-tokenized similarity-derived identifier bound to anchor-local entropy” refers to a raw or lightly processed feature vector derived from biometric or interaction signals under anchor-local entropy control, used directly for similarity comparison against stored reference vectors rather than being hashed into a fixed-length cryptographic token, the identifier being bound to anchor-local entropy such that it cannot be reproduced outside the physical continuity anchor device without access to the same entropy source.

“Agent state lineage artifact” refers to a cryptographic data structure generated within the secure processing enclave of the continuity anchor device and bound to a specific agent continuity state snapshot, comprising at least a cryptographic hash of the agent continuity state data, a monotonic sequence number, a hash-chain link to the immediately preceding agent state lineage artifact, and a digital signature produced using the anchor's non-exportable key material, such that any rollback, unauthorized duplication, or forking of agent continuity state produces a detectable discontinuity in the hash chain that is verifiable exclusively within the continuity anchor device.

“Algorithm-agile cryptographic module” refers to a cryptographic processing component within the secure processing enclave of the continuity anchor device configured to execute cryptographic operations using interchangeable algorithm implementations selectable from classical, post-quantum, and hybrid classical plus post-quantum algorithms, enabling cryptographic algorithm transitions without re-enrollment of biometric signals, re-derivation of continuity tokens from raw signals, or cloud-side key migration, thereby providing cryptographic sovereignty over a twenty-year operational horizon.

“Sovereign mesh” refers to a peer-to-peer network of physical continuity anchor devices that exchange mesh-verified artifacts, propagate collective freeze signals, and execute collective anomaly detection without any centralized coordination infrastructure, cloud-hosted governance servers, or escrowed key material, and in which each participating anchor device must present a valid manufacturer-signed attestation certificate to receive a positive mesh trust score, with software-only anchors, cloud-hosted anchors, and anchors presenting only self-signed credentials receiving a mesh trust score of zero and being excluded from collective anomaly detection voting and freeze signal propagation.

### 6.1 System Architecture

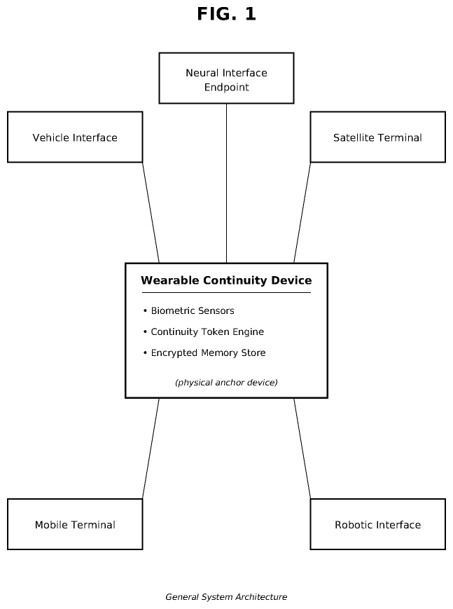

As shown in FIG. 1, the system comprises a continuity anchor device associated with a user. In many embodiments, the continuity anchor device is implemented as a wearable device such as a pendant, bracelet, ring, or head-mounted unit. In other embodiments, the continuity anchor device is implemented as a mobile terminal, vehicle-integrated console, neural interface gateway, robotic node, or other form factor.

The continuity anchor device includes one or more biometric or interaction-derived sensors, such as:
pulse or heart rate sensors;
thermal or skin temperature sensors;
inertial measurement units, accelerometers, or gyroscopes;
electro-dermal or galvanic skin response sensors;
neural-adjacent electrophysiological sensors;
microphones or vocal cadence analyzers;
capacitive, touch, or typing rhythm sensors;
gaze, motion, or additional interaction pattern detectors.

The continuity anchor device executes an identity derivation engine that processes raw sensor data locally to generate a continuity token. This token represents an anonymized biometric or interaction profile. Raw biometric identifiers and feature vectors need not be stored in non-volatile memory, nor transmitted outside the continuity anchor device.

A locally encrypted memory store within or under the control of the continuity anchor device indexes conversational state, session context, user preferences, conversation history fragments, continuity metadata, or other user-interactive information to the continuity token. The encrypted memory store may be implemented using symmetric or asymmetric cryptography and may rely on secure enclaves or trusted execution hardware.

Example: In a vehicular use case, the continuity anchor device (worn as a pendant or integrated into the steering column) detects pulse and motion signals while the user is driving, derives a continuity token, and stores a conversation about navigation preferences, calendar entries, and entertainment selections keyed to the token. Upon the user's arrival home, the same continuity anchor device interacts with a domestic robotic system; the robotic system receives continuity cues from the anchor device and restores the preferences and conversation context seamlessly.

### 6.2 Continuity Restoration

Upon reconnection of the continuity anchor device to any conversational user-interface node, the identity derivation engine acquires fresh biometric or interaction-derived signals and determines whether a previously derived continuity token has been re-detected following one or more interruption events, including:
device transitions;
power loss or reboot;
network interruptions;
idle periods or lapse of user interaction;
removal and re-association of the continuity anchor device with the user.

Upon successful token recognition, the continuity restoration engine retrieves associated session state and re-establishes the contextual conversational environment without requiring network authentication, credential entry, or cloud retrieval of stored memory. Restoration may include resuming a prior dialog, reinstating user-specific preferences, or reconstituting the last known interaction state.

Example: After a two-hour idle period, the continuity anchor device re-detects the continuity token upon sensing a valid live-user biometric pattern and restores a conversation on a mobile terminal, optionally adjusting response latency to match the user's recent typing rhythm.

### 6.3 Conversational User-Interface Nodes

As shown in FIG. 1, conversational user-interface nodes may operate on any computing platform capable of exchanging user-interactive data with the continuity anchor device, including but not limited to:
wearable devices;
vehicles and autonomous transport platforms;
robotic systems or assistive robotics;
mobile terminals or phones;
fixed installations, kiosks, or retail terminals;
entertainment systems or audiovisual terminals;
satellite communication terminals or spacecraft consoles;
head-mounted displays or spatial projection systems;
neural interface endpoints;
cloud-hosted conversational or AI services.

These nodes do not persist long-term personal identity data and rely solely on ephemeral continuity tokens or token references exchanged locally with the continuity anchor device to obtain continuity context. Session data may be streamed from the continuity anchor device or reconstructed based on state information supplied by the continuity anchor device.

Example: In a vehicle-to-robot transition, the continuity anchor device hands off an ongoing conversation about daily tasks from the car's infotainment system to a home robotic assistant without transmitting raw biometric data to either system.

### 6.4 Token Derivation and Encryption

The continuity token is generated using local cryptographic derivation mechanisms incorporating:
biometric or interaction signal preprocessing and normalization;
statistical entropy quantization or feature extraction;
rolling feature vector construction over sliding windows;
cryptographic hashing functions, such as SHA-256 or similar primitives.

Tokens are transient, revocable, and non-invertible, ensuring that personally identifiable biometric or neural signals cannot be reconstructed from the stored continuity data. The continuity anchor device may rotate or refresh continuity tokens periodically or in response to security events.

The encrypted memory store uses symmetric or asymmetric cryptographic encryption to prevent unauthorized extraction of session or identity contextual data. Neither raw biometric data nor full feature vectors are stored in non-volatile memory or transmitted externally. In some embodiments, only truncated token indices and encrypted session payloads are stored.

### 6.4.1 Example Token Generation Algorithm

In one embodiment, the identity derivation engine samples pulse rate and motion data at predetermined sampling frequencies. Pulse rate is sampled at 32-128 Hz and motion from a three-axis accelerometer is sampled at 50-200 Hz. The engine computes, over a sliding time window of 5-20 seconds, a biometric feature vector comprising at least:
(i) an average pulse rate;
(ii) a pulse rate variance;
(iii) an average acceleration magnitude; and
(iv) an acceleration variance.

Each feature is normalized into a bounded numeric range and quantized into a fixed number of bits (for example, 8-12 bits per dimension). The quantized values are concatenated into a feature string and combined with a device-specific secret value stored in a secure enclave. A cryptographic hashing function, such as SHA-256, is applied to the concatenated feature string and device secret to produce a digest. A subset of the digest bits (for example, 128 bits) is used as the continuity token. The token is non-invertible with respect to the underlying biometric measurements.

### 6.4.1.1 Worked Example—Continuity Token Generation and Matching

In one illustrative example:
A pulse sensor reports heart rate samples with an average of 72.4 bpm and variance of 4.1.
A three-axis accelerometer reports motion magnitudes averaging 0.032 g with variance of 0.009.

The identity derivation engine forms a feature vector F=[72.4, 4.1, 0.032, 0.009] and normalizes it to a bounded interval, yielding F′. Each component is quantized into fixed-bit integer representation Q. The quantized values are concatenated into a feature string S. S is concatenated with a device-specific secret D stored in a secure enclave, resulting in X.

A cryptographic hash H=SHA256(X) is computed, and a predetermined subset of bits is truncated to produce the continuity token T. Upon subsequent operation, new biometric samples produce a re-derived vector yielding a second token T′. A token comparison module computes the Hamming distance HD(T, T′) between T and T′. If HD(T, T′) is less than or equal to a threshold (e.g., 10 bits out of 128 bits), the tokens are considered matched and the continuity confidence threshold is satisfied. The indexed continuity state data may then be retrieved from the encrypted local memory store to restore the user session. If the threshold is not satisfied, continuity restoration is denied.

This process ensures robustness to transient biometric fluctuations while preventing reconstruction of underlying biometric measurements from the continuity token.

In informal prototype testing conducted entirely offline using pulse-rate and motion-derived signals, the continuity token system consistently exceeded a same-user matching rate of zero point nine five across repeated sessions, with low false acceptance, without reliance on any network connectivity or centralized identity service.

### 6.4.2 Example Token Matching

When a new continuity token is generated, a token comparison module computes a similarity metric between the new token and one or more previously stored reference tokens. In one embodiment, the similarity metric is a Hamming distance between token bit strings. In other embodiments, similarity may be computed using correlation coefficients, Euclidean or cosine distance in an embedding space, or probabilistic matching.

If the similarity metric between the new token and a stored reference token satisfies the continuity confidence threshold, the system treats the tokens as a match and authorizes retrieval of associated session context. If the similarity metric does not satisfy the threshold for any stored token, continuity restoration is denied, and no session context is loaded.

### 6.4.3 Continuity State Machine Operation

In some embodiments, continuity management is performed using a multi-state execution model. The system operates according to the following states:
1. Enrollment State—the continuity anchor device acquires biometric or interaction-derived signals and generates an initial continuity token associated with a new encrypted session memory entry.
2. Active Continuity State—the system continuously refreshes token derivation for ongoing session verification and may update encrypted session context incrementally.
3. Matching State—upon reconnection, idle interruption, or interface transition, the continuity anchor device computes a re-derived continuity token and compares it to stored tokens using similarity metrics.
4. Authorization State—if confidence thresholds are met, associated session context is restored or partially restored.
5. Revocation State—if mismatch or tamper detection occurs, the associated continuity token and its indexed memory state are invalidated and optionally erased.
6. Re-Enrollment State—upon user consent or security reset, new continuity tokens are generated and continuity resumes.

This state-machine logic is executed locally on the continuity anchor device without reliance on centralized servers or cloud identity services.

A pseudocode representation:
WHILE system_active:
   SAMPLES←acquire_sensor_window( )
   F←normalize_features(SAMPLES)
   Q←quantize(F)
   X←concat(Q, device_secret)
   TOKEN_new←hash(X)
   IF stored_tokens empty THEN
      store(TOKEN_new, session_state)
      state←ACTIVE
   ELSE
      match_found←FALSE
      FOR each TOKEN_old in stored_tokens:
         IF HAMMING(TOKEN_new, TOKEN_old)<=threshold THEN
         restore_session(TOKEN_old)
         state←AUTHORIZED
         match_found←TRUE
         BREAK
      IF NOT match_found THEN
         deny_continuity( )
         state←REVOKE
END WHILE

### 6.5 Offline Operation

The continuity anchor device and user-interface nodes may function independently of persistent network connectivity. All continuity restoration operations can be executed locally or via direct device-to-device communication mechanisms without cloud dependency.

The system can operate indefinitely in offline mode while still providing continuity restoration based solely on locally stored tokens and encrypted memory. Continuity assistance cues, such as subtle prompts or memory reinforcement signals, do not generate any persistent data outside the continuity anchor device, reinforcing privacy guarantees.

Example: In a remote area without network coverage, the continuity anchor device restores a session from local memory upon reboot and resumes interaction with a nearby offline terminal.

### 6.6 Additional Embodiments—Cognitive Continuity and Liveness Verification

### 6.6.1 Neural Echo/Passive Cognitive Continuity

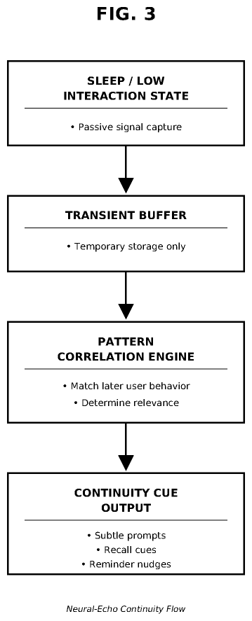

In some embodiments illustrated in FIG. 3, the continuity anchor device may passively detect non-semantic physiological or neural-adjacent signal patterns during periods of reduced interaction or sleep states.

Such signals are:
temporarily buffered in local volatile memory;
summarized into non-semantic statistical measures;
not semantically interpreted or decoded;
not transmitted to any remote system.

Upon subsequent waking interactions, current user activity patterns may be correlated with buffered activity signatures to determine potential contextual relevance. When a correlation threshold is satisfied, the system may generate non-explicit continuity assistance outputs selected from:
subtle prompts;
recall-reinforcement cues;
memory enhancement signals;
nudge notifications.

These outputs do not constitute interpretation of dream content or direct decoding of user thoughts, but serve solely to reinforce continuity between subconscious activity and waking task completion.

In one embodiment, the continuity anchor device samples physiological signals such as heart rate variability and skin conductance at a low sampling frequency (e.g., 0.5-4 Hz) during periods when the user is detected as inactive or sleeping. The sampled values are stored in a circular buffer representing a rolling time window (e.g., 30-90 minutes) and are periodically summarized into numerical statistics. Upon detection of waking interaction, the system computes similarity metrics between the summarized physiological statistics and recent interaction patterns; if a threshold level of correlation is detected, the system triggers a predetermined cue pattern (such as a brief vibration or tone) associated with a previously stored task reminder.

At no point are the buffered physiological signals transformed into decoded semantic content or used for medical analysis.

### 6.6.2 Liveness and Anti-Spoofing Verification

In some embodiments, the continuity anchor device applies liveness validation to ensure continuity authorization is based on genuine live-user biometric sampling rather than spoof replication. Liveness measures may include:
challenge-response testing of pulse-rate variability over randomized sampling windows;
sensor fusion cross-validation between pulse, motion, thermal, and electro-dermal signals to detect physiological coherence;
detection of temporal anomalies inconsistent with continuous biological signal generation;
detection of static or replayed signal patterns indicative of recording attacks.

If spoofing or replay patterns are detected, continuity matching is denied, revocation protocols are initiated, and memory entries may be invalidated or erased according to safety policies.

### 6.7 Privacy and Data Control

No personally identifiable biometric data, raw neural recordings, dream content, or unprocessed sensor streams are stored permanently or transmitted externally. All continuity tokens, buffers, memory indexing, and continuity restoration operations are executed locally under control of the continuity anchor device.

User memory may be selectively retained, erased, or purged based on user preferences, inactivity thresholds, or regulatory requirements. No cloud-based biometric identity storage or centralized session continuity servers are required.

### 6.8 Security and Tamper Protection

The continuity anchor device can include tamper detection circuits, encrypted secure enclaves, write-once memory fusing mechanisms, and hardware integrity checks configured to trigger cryptographic erasure of stored continuity keys, encrypted memory data, and associated continuity tokens upon detection of unauthorized access attempts or tampering.

In docking-enabled embodiments, any external docking station or host device participating in controlled data access is further configured to cryptographically erase temporary session keys, cached continuity data, and authentication credentials upon termination of the session, ensuring that no user memory, continuity state, or biometric-derived data remains accessible outside the continuity anchor device. All such security and tamper protection operations are executed locally and do not depend on network connectivity or cloud services.

### 6.9 Commercial and Software Integration

The system may operate with local transaction authorization mechanisms in which micro-transaction or local access triggers initiate temporary enhanced continuity features or session privileges without dependency on centralized accounts, remote identity servers, or cloud-based validation. In payment-enabled embodiments, the continuity anchor device generates transaction authorization requests, verifies cryptographic receipts or zero-knowledge proofs, and updates a local time-locked authorization register.

Transactions are generated, validated, and recorded locally. Authorization updates are written exclusively to the local authorization register tied to the continuity token. Variable transaction parameters may include session duration, feature access, or other operational enhancements defined by local policy modules. No raw biometric data, detailed continuity state, or network-based identity information is transmitted externally for monetization. Transactions do not rely on network communication for validation, supporting fully offline operation.

Reflection pauses between 0.5 and 3 seconds may be applied to responses to simulate human thoughtfulness, enhance perceived quality, and avoid masking latency. These local transaction authorization mechanisms function independently of biometric identity derivation and remain subordinate to the privacy and safety protections described herein.

### 6.9.1 Micro-Transaction Validation Protocol

In embodiments supporting micro-transactions or local access unlocks, the transaction-based access control module executes a cryptographic validation protocol independent of cloud identity systems. A representative flow includes:
Step A: The continuity anchor device generates a locally issued transaction request containing a time stamp, session continuity token hash reference, feature unlock identifier, and transaction request parameters based on local policy.
Step B: A local or optionally connected payment processing subsystem returns a cryptographic payment confirmation receipt including a transaction validation signature or proof.
Step C: The continuity anchor device validates the receipt using signature verification or zero-knowledge proof techniques without exposure of raw biometric data or full continuity tokens.
Step D: Upon validation, the continuity restoration engine updates a local time-locked authorization register to permit enhanced session functionality or extended access intervals.
Step E: All transaction generation, validation, and authorization operations are executed locally; no continuity state, raw biometric data, or user memory is transmitted externally.

### 6.10 Clinical Disclaimer

The disclosed system does not provide medical diagnosis, mental health evaluation, dream interpretation, or neural therapeutic treatment. Neural-adjacent detection serves only as a passive contextual continuity support mechanism and does not decode neurological content or cognitive intent.

### 6.11 Policy-Adaptive Continuity Operation

In certain embodiments, the biometric continuity token system applies one or more jurisdictional, enterprise, or regulatory policy profiles that dynamically govern the operation of continuity token processing, session state retention, authorization verification, or metadata disclosure behaviors.

Policy profiles may specify that continuity operations execute in one or more selectable compliance modes including:
a) a fully private local-operation mode in which continuity tokens and session memory are generated, stored, matched, and erased exclusively on the continuity anchor device without any external reporting of continuity state or metadata;
b) a regulated compliance mode in which a subset of cryptographically verifiable session metadata or authorization records are escrowed, encrypted, or transmitted to a designated compliance validation endpoint without exposure of raw biometric signals, neural-adjacent signals, or personal interaction content; and
c) a hybrid operation mode in which token derivation and session continuity remain local while authorization or audit confirmation receipts are periodically synchronized to compliance infrastructure systems according to jurisdictional or enterprise rules.

Selection or switching of policy profiles may be configured automatically based on device geolocation, regulatory instruction broadcasts, enterprise security directives, or user-authorized overrides. In all cases, the continuity token derivation, encrypted memory indexing, similarity-matching algorithms, and restoration logic remain locally executed on the continuity anchor device, ensuring that core continuity capabilities operate independently of centralized identity control.

### 6.12 Protocol-Based Continuity Synchronization

In certain embodiments, the system implements a distributed continuity synchronization protocol defining structured message formats, cryptographic continuity identifiers, handshake sequences, reconciliation rules, and state restoration ordering logic for transferring and synchronizing user or agent interaction context across heterogeneous computing platforms. The term “continuity identifiers” as used in this disclosure encompasses continuity tokens, entropy-based handles, and non-tokenized similarity-derived identifiers as defined in Section 6.0.

The protocol governs:
transmission of continuity token references or cryptographic hashes between user-interface nodes and the continuity anchor device;
cryptographically authenticated session-state reconciliation requests and acknowledgments;
conflict resolution handling between partial or concurrent interaction streams originating from different interface nodes;
session restoration staging for continuation of conversational flow following device transitions or network interruptions.

The protocol operates independently of any single interface platform and may be implemented within hardware, firmware, software applications, or virtualized environments across devices operated by differing vendor ecosystems or ownership domains. Protocol execution does not require shared persistent user accounts or centralized identity directories.

### 6.13 Digital Persona and Autonomous Agent Continuity

In certain embodiments, continuity tokens may be derived not only from biometric or interaction-derived human signal sources but additionally from digital persona signatures, behavioral interaction profiles, or autonomous agent state fingerprints representing persistent conversational or operational identities of non-human or semi-autonomous entities.

Accordingly, the continuity system supports session continuity not only between computing platforms associated with human users, but also between interacting digital agents, co-piloting assistants, virtual personas, or neural-simulation-derived identity constructs wherein continuity identification is established via cryptographically derived interaction-state signatures rather than biological anchoring.

The encrypted memory indexing and continuity restoration engines process such persona-derived continuity tokens using the same similarity metrics and threshold confidence mechanisms to preserve persistent conversational context across computing platforms for both human and non-human identity entities.

### 6.14 Hardware-Neutral Anchor Implementations

In certain embodiments, the continuity anchor device may be implemented as a physical wearable apparatus, mobile terminal, implanted computing module, vehicle-integrated computing environment, robotic subsystem node, neural interface gateway, distributed trusted execution container, or fully virtualized cryptographic persona environment.

Such implementations encompass both dedicated hardware anchors and software-instantiated anchors operating within secure enclaves, trusted execution environments, containerized compute nodes, peer-to-peer mesh routers, or ledger-bound cryptographic entities. In all embodiments, the continuity token generation, encrypted memory indexing, similarity matching, authorization updating, and restoration logic remain functionally equivalent, independent of physical or virtual embodiment.

Notwithstanding the foregoing, in the embodiments described in Sections 6.15 through 6.23 and Section 6.24 and recited in the claims of the present continuation-in-part as requiring a physically integrated secure processing enclave, non-exportable hardware-bound key material, an authorization artifact generator, physical possession, or sovereign mesh participation, the continuity anchor device must be implemented as a physical continuity anchor device having a physically integrated secure processing enclave; in such embodiments, software-only implementations, cloud-hosted implementations, and remote-service implementations of the continuity anchor device are expressly excluded from the scope of those embodiments.

### 6.15 Cloud-Sovereign Anchor Architecture and Physical Integration

In preferred embodiments, the secure processing enclave of the continuity anchor device is physically disposed within and exclusively integrated into the physical continuity anchor device, and is not instantiable as, substitutable by, or satisfiable through any remote service, cloud-hosted execution environment, network-accessible trusted execution environment, or any enclave whose execution is initiated, managed, or terminable by a third-party operator or remote infrastructure provider.

Remote attestation evidence alone-including remote TEE attestation certificates, cloud HSM proof-of-presence, and network-based cryptographic proofs of enclave integrity-is insufficient, by itself and absent satisfaction of on-device physical possession and liveness conditions, to authorize any continuity restoration, governed release, or collective freeze signal enforcement. The non-exportable key material of the continuity anchor device cannot be backed up, escrowed, mirrored, or re-hosted by any cloud-hosted key management service, third-party key escrow service, remote hardware security module, or network-accessible management interface. Cloud-hosted signing services, remote attestation services, and network-accessible trust registries are insufficient to satisfy the authorization artifact requirement.

### 6.16 Agent Continuity State Lineage and Rollback Prevention

In certain embodiments, the continuity anchor device maintains a hash-chained agent state lineage for each artificial intelligence agent whose continuity state is indexed to a continuity token. Each agent state transition generates an agent state lineage artifact comprising: a cryptographic hash of the current agent continuity state data, a monotonically incrementing sequence number maintained within the secure processing enclave, a hash-chain link comprising the cryptographic hash of the immediately preceding agent state lineage artifact, and a digital signature produced using the continuity anchor device's non-exportable key material.

Prior to authorizing restoration of agent continuity state, the continuity anchor device verifies the agent state lineage artifact sequence by confirming: the sequence number of the presented artifact exceeds all previously verified sequence numbers for this agent continuity token; the hash-chain link correctly corresponds to the cryptographic hash of the previously verified agent state lineage artifact; and the digital signature verifies using the anchor's locally stored verification material. If verification fails-indicating a rollback attempt, unauthorized duplication, or forked instantiation-restoration is denied, the continuity token is invalidated, and the safety governance layer is notified.

The agent state lineage artifacts are stored exclusively within the secure processing enclave and are not readable, transferable, or verifiable by any remote service. The hash-chain structure ensures that an adversary with access to a backup of agent continuity state cannot forge a valid lineage artifact without access to the continuity anchor device's non-exportable key material. In one embodiment, the lineage sequence number is maintained using a hardware-backed monotonic counter within the secure processing enclave, such that the counter cannot be reset or decremented by any software, firmware, or remote interface.

### 6.17 Sovereign Mesh Formation and Collective Freeze Propagation

In certain embodiments, a plurality of physical continuity anchor devices establish a sovereign mesh by exchanging cryptographically signed peer introduction messages over local or peer-to-peer communication channels. Each physical continuity anchor device verifies the digital signature of a received peer introduction message using a locally stored root attestation certificate before admitting the peer to its mesh neighbor table. A peer presenting a valid manufacturer-signed attestation certificate from a recognized root authority receives a baseline mesh trust score of one hundred. A peer presenting a self-signed or software-only credential receives a mesh trust score of zero and is excluded from collective anomaly detection voting and freeze signal propagation. A peer identified as a cloud-hosted anchor or a software-instantiated anchor without physical hardware receives a mesh trust score of zero regardless of any attestation certificate presented, as cloud-hosted and software-only implementations cannot satisfy the physical possession requirements of the sovereign mesh architecture.

Collective anomaly detection is implemented as a threshold voting protocol in which each physical continuity anchor device independently computes a local anomaly score based on its behavioral drift metrics and continuity state data, periodically broadcasts an anonymized anomaly score digest comprising a cryptographic hash of the anomaly evidence and a numerical score, and accumulates received digests from mesh neighbors. An anchor evaluates whether the sum of scores from a configurable quorum of mesh neighbors exceeds a collective anomaly threshold and, upon exceeding the threshold, generates a collective freeze signal even if its own local anomaly score would not independently trigger the individual threshold.

The collective freeze signal comprises a cryptographic hash of the detected anomaly evidence, a timestamp, the anchor identity digest of the detecting anchor, and a digital signature produced using the detecting anchor's non-exportable key material. The collective freeze signal is propagated peer-to-peer to all mesh neighbors. Each receiving physical continuity anchor device independently verifies the digital signature against the sender's known anchor identity digest before enforcing a local freeze state using its own non-exportable key material. No centralized command authority, cloud-hosted governance server, or network-accessible management interface is required to initiate, propagate, or enforce the freeze state.

In one embodiment, behavioral drift is detected when a longitudinal interaction cadence metric deviates more than twenty-five percent from a thirty-day rolling baseline, coinciding with a forty percent increase in heart-rate variance, triggering collective freeze signal generation.

### 6.18 Post-Quantum Cryptographic Hardening and Algorithm Agility

In certain embodiments, all cryptographic functions executed by the continuity anchor device-including continuity token derivation, authorization artifact generation, agent state lineage artifact generation and verification, mesh-verified artifact signing, zero-knowledge proof generation, and collective freeze signal signing-utilize post-quantum cryptographic primitives resistant to quantum computing attacks, including lattice-based schemes such as CRYSTALS-Kyber and CRYSTALS-Dilithium, hash-based schemes such as SPHINCS+, code-based schemes, and hybrid classical plus post-quantum modes.

The algorithm-agile cryptographic module within the secure processing enclave supports runtime algorithm selection without re-enrollment of biometric signals, re-derivation of continuity tokens from raw signals, or migration of non-exportable key material outside the enclave boundary. All algorithm transitions are performed exclusively within the secure processing enclave using non-exportable key material, enabling the sovereign mesh to maintain cryptographic security against quantum computing adversaries over a twenty-year operational horizon without cloud-side key migration or service interruption.

In one hybrid embodiment, authorization artifact signing and agent state lineage artifact signing both compute an ECDSA signature using a classical elliptic curve key and a Dilithium signature using a post-quantum key, concatenating both signatures. Verification requires successful verification of both signatures, ensuring that compromise of either component alone is insufficient to forge a valid artifact.

### 6.19 Verifiable Compute and Output Attestation

The system further comprises a verifiable compute module within the governed execution enclave that generates attestations proving an AI output or state transition was produced under the governed release rule set and continuity token without disclosing inputs, model weights, or restricted continuity state. Attestations may use zero-knowledge proofs, succinct non-interactive arguments of knowledge (SNARKs/STARKs), or successor verifiable computation systems. In one embodiment, the verifiable compute module generates a non-interactive zero-knowledge proof of anomaly absence proving that no component of the behavioral metric vector exceeds the anomaly detection thresholds, without disclosing the metric values or threshold parameters.

### 6.20 Successor Anchor and Dual-Anchor Authorization for Agent Continuity

In certain embodiments, high-privilege agent continuity operations-including agent state lineage reset after detected rollback, reinstantiation of an agent after a forked-instance denial, and governed release of full agent continuity state-require dual-anchor authorization comprising valid authorization artifacts from both the primary continuity anchor device and a pre-enrolled guardian anchor device, each generated using their respective non-exportable key material and verified within the primary anchor's secure processing enclave. No remote service can substitute for either anchor's physical authorization artifact.

Successor anchor enrollment for agent continuity uses a physical co-presence enrollment protocol in which the primary anchor and the successor anchor are physically co-located and each generates a mutually binding enrollment artifact. Upon loss of the primary anchor, the successor anchor can authorize re-derivation of agent continuity tokens and re-initialization of the agent state lineage hash chain without requiring cloud-hosted recovery services.

### 6.21 Multi-User and Organizational Agent Delegation

In certain embodiments, the governed release rule set supports granular delegation of agent sub-tokens with revocable, time-bound, and scope-limited rights for multi-user, organizational, or multi-agent sharing while preserving individual sovereignty. All delegation actions require anchor-local authorization artifact generation using non-exportable key material. Sub-token revocation is enforced by a delegation revocation registry within the secure processing enclave. Delegation is consent-chained across physical anchor devices and may include collective freeze capabilities that propagate across the sovereign mesh.

### 6.22 One-Time Artifact Validity and Anti-Replay Enforcement

In certain embodiments, the continuity anchor device enforces one-time validity of authorization artifacts and agent state lineage artifacts by maintaining a monotonically incrementing nonce counter within the secure processing enclave, wherein each generated artifact incorporates the current nonce value as a bound field, and wherein the enclave increments the counter upon successful artifact verification such that any subsequent presentation of an artifact containing a previously consumed nonce value fails verification. In an alternative embodiment, a fixed-capacity artifact revocation register stores identifiers of verified artifacts within a rolling time window; any artifact identifier matching an entry in the revocation register is rejected as a replay attempt. The nonce counter and revocation register are not readable, resettable, or recoverable by any remote service.

### 6.23 Zero-/Knowledge Proof and Verifiable Computation Compatibility

The continuity anchor execution environment generates zero-knowledge proofs demonstrating compliance with governed release rule sets, absence of anomaly conditions, agent state lineage integrity, or satisfaction of entitlement conditions without disclosing restricted continuity state, biometric signals, non-exportable key material, agent behavioral metrics, or governed release rule parameters. All proof generation operations are performed exclusively within the secure processing enclave using non-exportable key material. Zero-knowledge proofs, SNARKs, STARKs, and successor verifiable computation systems are supported without requiring cloud-side trusted setup or network-accessible proof generation services.

### 6.24 Tolerance-Processing for Continuity Identifier Derivation

In certain embodiments, similarity-based matching for continuity restoration is performed on stabilized intermediate representations of the underlying source inputs rather than directly on the cryptographic output of an unmodified hash function. As used herein, the term “continuity identifier” encompasses continuity tokens, entropy-based handles, and non-tokenized similarity-derived identifiers as defined in Section 6.0; the tolerance-processing techniques described in this Section 6.24 are applicable to derivation and matching for each such sub-type.

In embodiments requiring tolerance to bounded variation in the source inputs of a continuity identifier, similarity evaluation is performed prior to final cryptographic commitment, within the secure processing enclave or trusted execution hardware of the physical continuity anchor device, on stabilized intermediate representations of the source inputs. Such stabilized intermediate representations may be produced by one or more of: a fuzzy extractor; a secure sketch combined with helper data and cryptographic re-hashing; a locality-sensitive hashing function applied to a normalized and quantized feature vector; an error-correcting code applied to a quantized feature representation in combination with stored helper data; or an enclave-internal stabilized feature representation derived from the normalized and quantized source inputs. In such embodiments, the cryptographic continuity identifier represents a stabilized output produced after such tolerance processing, rather than a raw output of a cryptographic hash applied directly to unstable biometric, behavioral, or state-derived inputs. In other embodiments, the similarity metric may be applied directly to the normalized and quantized feature representations, with a final cryptographic hash applied only after a successful similarity match has been determined within the secure processing enclave. These embodiments collectively avoid reliance on similarity comparisons performed solely on the avalanche output of an unmodified cryptographic hash function applied to slightly varying source inputs.

All helper data, stabilization parameters, error-correcting code parameters, and locality-sensitive hashing parameters used to produce stabilized intermediate representations are stored exclusively within the secure processing enclave of the physical continuity anchor device, are not transmitted externally, and are not exportable through any cloud-hosted service, remote attestation interface, or third-party operator. Tolerance processing is performed entirely within the physical device boundary of the continuity anchor device.

In a representative non-limiting example consistent with the foregoing tolerance-processing embodiments, a feature vector V representing one or more biometric, behavioral, or state-derived characteristic dimensions is normalized and quantized within the secure processing enclave to produce a quantized feature string S. A stabilized intermediate representation R is produced from S using one or more of the tolerance-processing techniques described above (such as application of a secure sketch with helper data, locality-sensitive hashing of the quantized feature representation, or enclave-internal feature stabilization). The concatenation R||D, where D is a non-exportable hardware-bound device-specific secret value retained within the secure processing enclave, is computed and a cryptographic hash function (such as SHA-256 or a post-quantum hash construction selected by the algorithm-agile cryptographic module of Section 6.18) is applied, producing a digest from which a predetermined number of bits forms the continuity identifier T. A subsequent redetermination using the same tolerance-processing path produces T′. A Hamming distance HD(T, T′) less than or equal to a predetermined threshold (for example, 12 bits out of 128 bits) satisfies the continuity confidence threshold. Alternatively, the similarity metric may be evaluated within the secure processing enclave on the stabilized intermediate representations R and R′ directly, with the cryptographic continuity identifier derived only following successful intermediate-level matching.

In embodiments where the continuity identifier comprises an entropy-based handle as defined in Section 6.0, the locality-sensitive hashing function or dimensionality-reduced representation of the feature vector serves as the stabilized intermediate representation, and similarity-based matching is performed directly on entropy-based handles without an intervening avalanche-output cryptographic hash. In embodiments where the continuity identifier comprises a non-tokenized similarity-derived identifier as defined in Section 6.0, the stabilized intermediate representation is bound to anchor-local entropy retained within the secure processing enclave such that the identifier cannot be reproduced outside the physical continuity anchor device.

### Alternative Embodiments

The present disclosure may be implemented across a wide range of hardware and software substrates including but not limited to:
wearable pendants, bracelets, rings, or head-mounted devices;
implanted computing modules or medical-grade devices;
hybrid biometric authentication accessories;
vehicle-mounted biometric terminals and infotainment systems;
robotic interface relays and home automation hubs;
satellite uplink identity modules and spaceborne computing systems;
secure virtualization containers or distributed ledger-anchored identities.

Communication methods may include wired ports, wireless RF links, Bluetooth Low Energy (BLE) communications, satellite uplinks, optical transceivers, bio-electrical couplings, or other physical or wireless channels.

Cryptographic derivation algorithms may include but are not limited to hashing, rolling entropy derivation, zero-knowledge proof tokenization, homomorphic encryption-assisted comparisons, or secure enclave-processed biometric transformations.

The present disclosure may be implemented across a wide range of hardware and software substrates. Cryptographic derivation algorithms may include post-quantum primitives, hybrid classical plus post-quantum modes, zero-knowledge proof tokenization, homomorphic encryption-assisted comparisons, or secure enclave-processed biometric transformations. The system is expressly adaptable to future cryptographic proof systems, secure hardware technologies, communication protocols, and non-semantic behavioral signals across any device or software form factor over a twenty-year horizon.

### Conclusion

The present disclosure enables secure and privacy-preserving continuity of interactive computing sessions across distributed devices without dependence on centralized cloud identity infrastructures or storage of personal biometric identifiers. By employing local continuity token derivation, encrypted local memory indexing, offline-capable continuity restoration, and protocol-based synchronization, the disclosed technology advances the state of biometric and interaction-based continuity computing systems for both human and digital personas.

The present disclosure enables secure, privacy-preserving, and verifiably contained AI continuity across distributed devices without dependence on centralized cloud identity infrastructures, cloud-hosted governance servers, or escrowed key material. By employing local continuity token derivation, agent state lineage protection, sovereign mesh collective freeze propagation, governed release, and post-quantum hardening with algorithm agility, the disclosed technology advances the state of AI continuity computing while preserving complete human sovereignty against centralized infrastructure dependency over a twenty-year operational horizon.

What is claimed is:

1. A distributed AI continuity governance and verifiable containment system comprising a sovereign mesh of physical continuity anchor devices, comprising:
a) a physical continuity anchor device comprising a physically integrated secure processing enclave containing non-exportable key material in hardware-enforced isolated memory, the secure processing enclave being not instantiable as, substitutable by, or satisfiable through any remote service, cloud-hosted execution environment, or network-accessible trusted execution environment, and the non-exportable key material being not mirrored, escrowed, or re-hosted by any cloud-hosted key management service or third-party key escrow service;
b) an identity derivation engine configured to derive a continuity identifier from one or more biometric signals, interaction-derived signals, or digital persona signatures combined with a device-specific or environment-specific secret value stored within the physically integrated secure processing enclave, the continuity identifier comprising at least one of a continuity token, a cryptographic derivative thereof, an entropy-based handle, or a non-tokenized similarity-derived identifier bound to anchor-local entropy;
c) an agent state lineage module configured to generate, within the physically integrated secure processing enclave using non-exportable key material, an agent state lineage artifact for each agent continuity state transition, the agent state lineage artifact comprising a cryptographic hash of the current agent continuity state data, a monotonically incrementing sequence number, a hash-chain link to the immediately preceding agent state lineage artifact, and a digital signature produced using the non-exportable key material, such that rollback, unauthorized duplication, and forking of agent continuity state produce detectable hash-chain discontinuities verifiable exclusively within the physical continuity anchor device;
d) an encrypted continuity state repository indexed to the continuity identifier, wherein decryption and release require generation of an anchor-local authorization artifact using non-exportable key material under exclusive cryptographic control of the physical continuity anchor device;
e) a governed release controller configured to control disclosure of continuity state data using at least one machine-executable governed release rule set;
f) a mesh protocol engine configured to coordinate peer-to-peer exchange of mesh-verified artifacts between physical continuity anchor devices without centralized coordination infrastructure, cloud-hosted routing servers, or network-accessible orchestration services, the mesh protocol engine executing collective anomaly detection across the sovereign mesh and assigning a mesh trust score of zero to software-only anchors, cloud-hosted anchors, and anchors presenting only self-signed credentials, excluding zero-score anchors from collective anomaly detection voting and freeze signal propagation; and
g) a collective freeze controller configured to generate and propagate a collective freeze signal peer-to-peer across the sovereign mesh upon detection of a safety, compliance, or behavioral drift event, each receiving physical continuity anchor device enforcing a local freeze state independently using its own non-exportable key material upon cryptographic verification of the collective freeze signal against the sender's anchor identity digest,
wherein the system enables continuity restoration upon re-detection of the continuity identifier satisfying a predefined continuity confidence threshold following an interruption event; wherein centralized identity provider authentication, remote account login, and cloud-hosted memory retrieval are insufficient by themselves to authorize continuity restoration absent anchor-local authorization artifact generation using non-exportable key material; wherein remote attestation evidence, by itself and absent satisfaction of on-device physical possession and liveness conditions, does not authorize continuity restoration or agent state lineage verification; wherein no centralized command authority is required to initiate, propagate, or enforce the freeze state across the sovereign mesh; and wherein the sovereign mesh maintains verifiable ecosystem-wide containment without centralized coordination infrastructure, cloud-hosted governance servers, or escrowed key material.

2. The system of claim 1, wherein the agent state lineage module verifies agent state lineage artifacts prior to authorizing restoration by confirming the sequence number exceeds all previously verified sequence numbers, the hash-chain link correctly corresponds to the previously verified artifact, and the digital signature verifies using locally stored verification material, and wherein verification failure causes denial of restoration, invalidation of the continuity token, and notification of the safety governance layer.

3. The system of claim 1, wherein the mesh protocol engine implements at least one of: (i) assigning a mesh trust score of zero to any continuity anchor device identified as operating in a cloud-hosted execution environment or as a software-only anchor without physical hardware integration, with zero-score devices excluded from collective anomaly detection voting and freeze signal propagation regardless of any attestation certificate presented; or (ii) validating a manufacturer-signed attestation certificate presented by each peer before admitting the peer to a mesh neighbor table, with peers presenting only self-signed or software-only credentials receiving a mesh trust score of zero regardless of any other characteristic.

4. The system of claim 1, wherein the collective freeze signal comprises a cryptographic hash of anomaly evidence, a timestamp, the anchor identity digest of the detecting anchor, and a digital signature produced using the detecting anchor's non-exportable key material, and wherein each receiving physical continuity anchor device independently verifies the digital signature against the sender's locally held anchor identity digest before enforcing a local freeze state.

5. The system of claim 1, wherein the mesh protocol engine implements collective anomaly detection as a threshold voting protocol in which each physical continuity anchor device independently computes a local anomaly score, broadcasts an anonymized anomaly score digest to mesh neighbors, and generates a collective freeze signal when the sum of scores from a configurable quorum of mesh neighbors exceeds a collective anomaly threshold, enabling detection of distributed low-amplitude anomalies that would evade single-anchor detection.

6. The system of claim 1, further comprising a continuity freeze controller configured to enforce a cryptographically locked freeze state during at least one of a safety event, compliance investigation, jurisdictional audit, or tamper detection condition, the freeze state being releasable only upon anchor-local authorization artifact generation using non-exportable key material within the physically integrated secure processing enclave.

7. The system of claim 1, wherein the agent state lineage module maintains the monotonically incrementing sequence number using a hardware-backed monotonic counter within the physically integrated secure processing enclave that cannot be reset or decremented by any software, firmware, or remote interface.

8. The system of claim 1, wherein all cryptographic operations utilize an algorithm-agile cryptographic module within the physically integrated secure processing enclave configured to execute operations using interchangeable algorithm implementations selectable from classical, post-quantum, and hybrid classical plus post-quantum algorithms, enabling cryptographic algorithm transitions over a twenty-year operational horizon without re-enrollment of biometric signals or cloud-side key migration.

9. The system of claim 8, wherein the algorithm-agile cryptographic module implements at least one of: (i) post-quantum algorithms comprising at least one of CRYSTALS-Kyber for key encapsulation, CRYSTALS-Dilithium for digital signatures, or SPHINCS+ for stateless signatures; or (ii) hybrid digital signatures wherein authorization artifact generation and agent state lineage artifact generation each compute both a classical digital signature and a post-quantum digital signature concatenated into the artifact, and wherein verification requires successful verification of both signatures such that compromise of either component alone is insufficient to forge a valid artifact.

10. The system of claim 1, further comprising a verifiable compute module within a governed execution enclave that generates attestations proving AI output or state transition compliance with governed release rule sets without disclosing inputs, model weights, or restricted continuity state, the attestations comprising at least one of zero-knowledge proofs, succinct non-interactive arguments of knowledge, or successor verifiable computation outputs generated exclusively within the physically integrated secure processing enclave using non-exportable key material.

11. The system of claim 1, wherein the continuity anchor device enforces one-time artifact validity by maintaining a monotonically incrementing nonce counter within the physically integrated secure processing enclave, binding the current nonce value to each generated authorization artifact, and rejecting any subsequent presentation of an artifact containing a previously consumed nonce value.

12. The system of claim 1, wherein the governed release controller generates a zero-knowledge proof demonstrating that no continuity state entry indexed to the continuity identifier is releasable under the current governed release rule set, without revealing continuity state contents, the continuity identifier, or governed release rule parameters, the proof being generated exclusively within the physically integrated secure processing enclave using non-exportable key material.

13. The system of claim 1, further comprising at least one of: (i) a dual-anchor authorization module configured to require valid authorization artifacts from both a primary physical continuity anchor device and a pre-enrolled guardian physical continuity anchor device, each generated using their respective non-exportable key material and verified within the primary anchor's physically integrated secure processing enclave, for authorizing high-privilege operations including agent state lineage reset and governed release of full agent continuity state; or (ii) a successor anchor module configured to execute physical co-presence enrollment of a successor anchor device, storing a recovery credential in the successor anchor device generated using the primary anchor's non-exportable key material during physical co-presence, enabling recovery without cloud-hosted services.

14. The system of claim 1, wherein the governed release rule set supports granular delegation of agent sub-tokens with revocable, time-bound, and scope-limited rights, wherein delegation actions require anchor-local authorization artifact generation using non-exportable key material, and wherein sub-token revocation is enforced by a delegation revocation registry within the physically integrated secure processing enclave.

15. The system of claim 1, wherein the system operates equivalently across cloud-connected, intermittently connected, offline, air-gapped, vehicular, satellite, and neural-interface deployment environments, maintaining identical security properties and containment guarantees regardless of network availability.

16. The system of claim 1, wherein each user-interface node receiving continuity state data or authorization artifacts is treated as untrusted, and wherein the physical continuity anchor device prevents any such node from reconstructing plaintext continuity state, generating valid authorization artifacts, or verifying agent state lineage artifacts even if the node operating system, hypervisor, or application layer is fully compromised.

17. The system of claim 1, wherein the physical continuity anchor device is the exclusive root of trust for all continuity restoration, agent state lineage verification, mesh participation, and containment enforcement operations; wherein agent state lineage artifacts are stored exclusively within the physically integrated secure processing enclave and are not readable, transferable, or verifiable by any remote service, cloud-hosted governance server, or software-only anchor implementation; and wherein no cloud infrastructure, remote service, or third-party operator is required or sufficient to serve as root of trust for any such operation.

18. A computer-implemented method for distributed AI continuity governance and verifiable containment, executed by a physical continuity anchor device comprising a physically integrated secure processing enclave containing non-exportable key material that is not instantiable as, substitutable by, or satisfiable through any remote service, cloud-hosted execution environment, or network-accessible trusted execution environment, the method comprising:
a) deriving a continuity identifier from one or more biometric signals, interaction-derived signals, or digital persona signatures combined with a device-specific or environment-specific secret value stored within the physically integrated secure processing enclave;
b) generating, within the physically integrated secure processing enclave, an agent state lineage artifact for each agent continuity state transition comprising a cryptographic hash of the agent continuity state data, a monotonically incrementing sequence number, a hash-chain link to the immediately preceding artifact, and a digital signature using non-exportable key material;
c) verifying agent state lineage artifacts prior to authorizing agent continuity restoration, denying restoration upon detection of sequence number discontinuity, hash-chain mismatch, or signature verification failure;
d) exchanging mesh-verified artifacts with one or more peer physical continuity anchor devices via a mesh protocol engine operating without centralized coordination infrastructure, assigning a mesh trust score of zero to software-only and cloud-hosted anchors and excluding them from collective anomaly detection;
e) propagating a collective freeze signal peer-to-peer across a sovereign mesh of physical continuity anchor devices upon detection of a safety, compliance, or behavioral drift event, each receiving device enforcing a local freeze state using its own non-exportable key material; and
f) restoring agent continuity when a similarity metric satisfies a predefined continuity confidence threshold and when agent state lineage verification passes and when the freeze state is not active,
wherein remote attestation evidence, by itself and absent satisfaction of on-device physical possession and liveness conditions, does not authorize continuity restoration or agent state lineage verification, and wherein all operations are executable without network connectivity.

19. The method of claim 18, further comprising executing collective anomaly detection as a threshold voting protocol accumulating anonymized anomaly score digests from mesh neighbors and generating a collective freeze signal when accumulated scores exceed a collective anomaly threshold.

20. The method of claim 18, further comprising executing all cryptographic operations using an algorithm-agile cryptographic module supporting runtime selection of classical, post-quantum, and hybrid classical plus post-quantum algorithms without re-enrollment of biometric signals or cloud-side key migration.

21. The method of claim 18, further comprising generating verifiable compute attestations proving AI output compliance with governed release rule sets without disclosing inputs, model weights, or restricted continuity state.

22. The method of claim 18, further comprising enforcing dual-anchor authorization requiring valid authorization artifacts from both a primary and a pre-enrolled guardian physical continuity anchor device for high-privilege agent continuity operations.

23. A non-transitory computer-readable medium storing machine-executable instructions that, when executed by one or more processors of a physical continuity anchor device comprising a physically integrated secure processing enclave containing non-exportable key material that is not instantiable as, substitutable by, or satisfiable through any remote service, cloud-hosted execution environment, or network-accessible trusted execution environment, and that is not mirrored, escrowed, or re-hosted by any cloud-hosted key management service, cause the physical continuity anchor device to:
a) derive a continuity identifier from one or more biometric signals, interaction-derived signals, or digital persona signatures combined with a device-specific or environment-specific secret value stored within the physically integrated secure processing enclave;
b) generate agent state lineage artifacts within the physically integrated secure processing enclave using non-exportable key material, each artifact comprising a cryptographic hash of agent continuity state data, a monotonically incrementing sequence number, a hash-chain link to the preceding artifact, and a digital signature, and verify agent state lineage artifacts prior to authorizing restoration;
c) generate authorization artifacts within the physically integrated secure processing enclave using the non-exportable key material, bound to the continuity identifier, the requested operation, and a freshness value, and rendered invalid upon successful verification;
d) exchange mesh-verified artifacts with peer physical continuity anchor devices via a mesh protocol engine without centralized coordination infrastructure, assigning a mesh trust score of zero to software-only and cloud-hosted anchors;
e) propagate collective freeze signals peer-to-peer across a sovereign mesh upon detection of safety, compliance, or behavioral drift events, each receiving device enforcing a local freeze state using its own non-exportable key material; and
f) restore agent continuity when a similarity metric satisfies a predefined continuity confidence threshold and when agent state lineage verification passes and when the freeze state is not active,
wherein remote attestation evidence, cloud-hosted key management services, centralized commands, and cloud-hosted governance servers are each insufficient by themselves to authorize continuity restoration, agent state lineage verification, or freeze state release absent anchor-local authorization artifact generation using non-exportable key material under exclusive cryptographic control of the physically integrated secure processing enclave.

24. The non-transitory computer-readable medium of claim 23, wherein the instructions further cause the physical continuity anchor device to execute all cryptographic operations using an algorithm-agile cryptographic module supporting post-quantum primitives and hybrid classical plus post-quantum modes over a twenty-year operational horizon.

25. The non-transitory computer-readable medium of claim 23, wherein the instructions further cause the physical continuity anchor device to enforce one-time artifact validity using a hardware-backed monotonic nonce counter within the physically integrated secure processing enclave.

26. The non-transitory computer-readable medium of claim 23, wherein the instructions further cause the physical continuity anchor device to execute dual-anchor authorization requiring valid authorization artifacts from both a primary and a pre-enrolled guardian physical continuity anchor device for high-privilege agent continuity operations.

27. The non-transitory computer-readable medium of claim 23, wherein the instructions further cause the physical continuity anchor device to enforce granular delegation of agent sub-tokens with revocable rights, maintaining a delegation revocation registry within the physically integrated secure processing enclave not readable or recoverable by any remote service.

28. The system of claim 1, wherein the physical continuity anchor device is implemented as a dedicated physical device that is physically separate and distinct from any heterogeneous user-interface node it serves, having no shared operating system, application processor, or memory space with any such node.

29. The system of claim 1, wherein restoration of agent continuity state is conditioned on local validation of proof of custody of the agent continuity state by the physical continuity anchor device using non-exportable key material, preventing unauthorized duplication or forked deployment of the artificial intelligence agent without requiring remote validation.

30. The system of claim 1, wherein the sovereign mesh continues to enforce containment and propagate collective freeze states even when individual physical continuity anchor devices are offline or unreachable, and wherein a single compromised or malfunctioning node cannot unilaterally release the freeze state across the sovereign mesh.
